(19) United States
(12) Patent Application Publication
(10) Pub. No.: US 2019/0009440 A1
(43) Pub. Date: Jan. 10, 2019

(54) Process of manufacturing foam molded articles

(71) Applicant: Wei-Hao Chang, Taichung (TW)

(72) Inventor: Wei-Hao Chang, Taichung (TW)

(21) Appl. No.: 16/128,543

(22) Filed: Sep. 12, 2018

(30) Foreign Application Priority Data
Jul. 18, 2018 (TW) 107124836

(51) Int. Cl. B29C 44/04; B29C 44/34; B29C 44/58

(52) U.S. Cl. CPC B29C 44/0461; B29C 44/356; B29K 2075/00; B29C 44/3415; B29C 44/58

(57) ABSTRACT

A process of manufacturing a foam molded article includes opening an open-closed molding system; applying a release agent into a female cavity section of the molding system; injecting PU into the female cavity section; closing the molding system; placing the closed molding system in a foaming device; activating the foaming device to heat the PU; forming a plurality of interconnecting first air pockets in an air permeable foam core of a foam molded article to be formed; forming a plurality of interconnecting second air pockets in each of a top surface and a bottom surface of the foam molded article respectively by involving a chemical reaction with the release agent wherein the second air pockets are in air communication with the first air pockets; opening the molding system; and removing the finished foam molded article from the molding system.

### BACKGROUND OF THE INVENTION

### 1. Field of the Invention

The invention relates to the manufacturing of foam molded articles and more particularly to a process of manufacturing foam molded articles having improved air permeability.

### 2. Description of Related Art

Referring to FIGS. 1 to 4, a conventional process of manufacturing foam molded articles is illustrated and comprises preparing a rectangular sheet A formed of polyurethane (PU) and cutting a plurality of disc shaped articles A1 out of the sheet A. The article A includes an air permeable foam core A11 and two airproof layers A12 releasably formed on top and bottom of the air permeable foam core A11 respectively.

Thus, the article A1 is not air permeable in nature (see FIG. 3). One may remove airproof layer A12 on the top of the article A1 to allow air trapped in the foam core A11 to exit (see FIG. 4). However, this is not convenient.

Thus, the need for improvement still exists.

### SUMMARY OF THE INVENTION

It is therefore one object of the invention to provide a process of manufacturing a foam molded article, comprising opening an open-closed molding system; applying a release agent into a female cavity section of the molding system; injecting an expandable elastomeric PU into the female cavity section; closing the molding system; placing the closed molding system in a foaming device; activating the foaming device to heat the expandable elastomeric PU; forming a plurality of interconnecting first air pockets in an air permeable foam core of a foam molded article to be formed; forming a plurality of interconnecting second air pockets in each of a top surface and a bottom surface of the foam molded article respectively by involving a chemical reaction with the release agent wherein the second air pockets are in air communication with the first air pockets; opening the molding system; and removing the finished foam molded article from the molding system.

The above and other objects, features and advantages of the invention will become apparent from the following detailed description taken with the accompanying drawings.

### BRIEF DESCRIPTION OF THE DRAWINGS

FIG. 1 is a perspective view of a PU sheet for manufacturing a foam molded articles according to the conventional art;

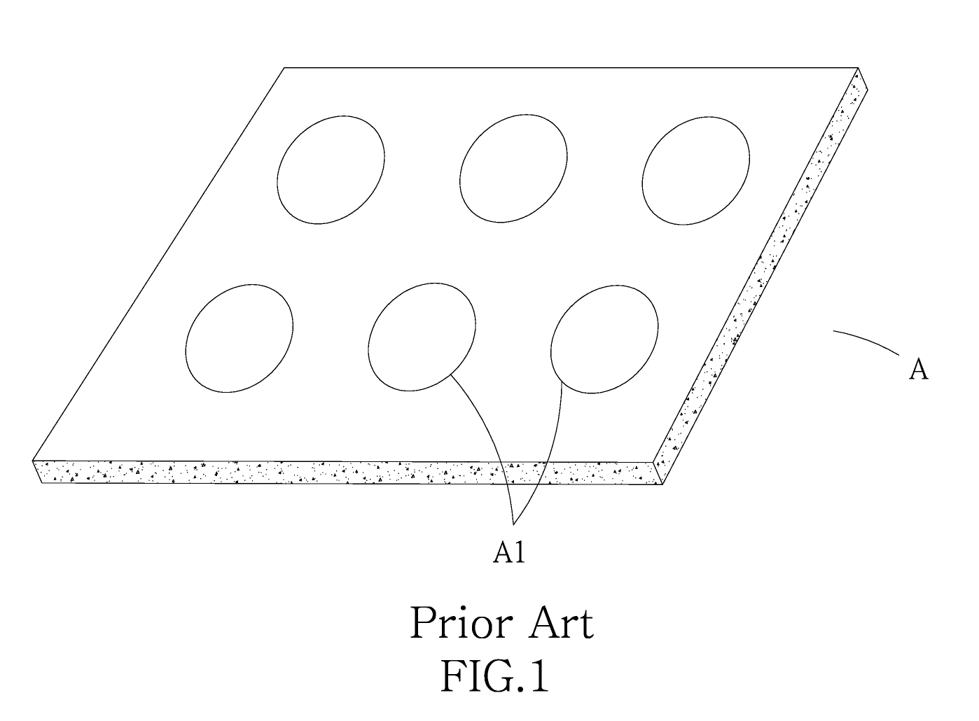

FIG. 2 is a perspective view of an article cut from the PU sheet;

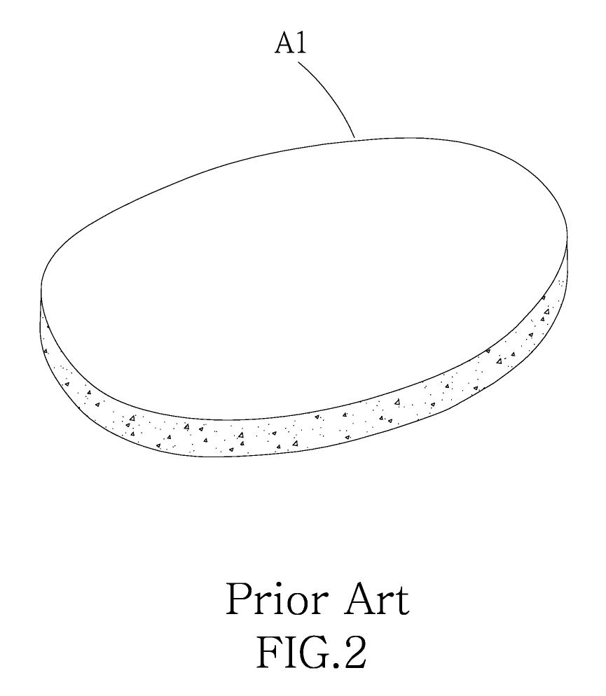

FIG. 3 is a longitudinal sectional view of the article;

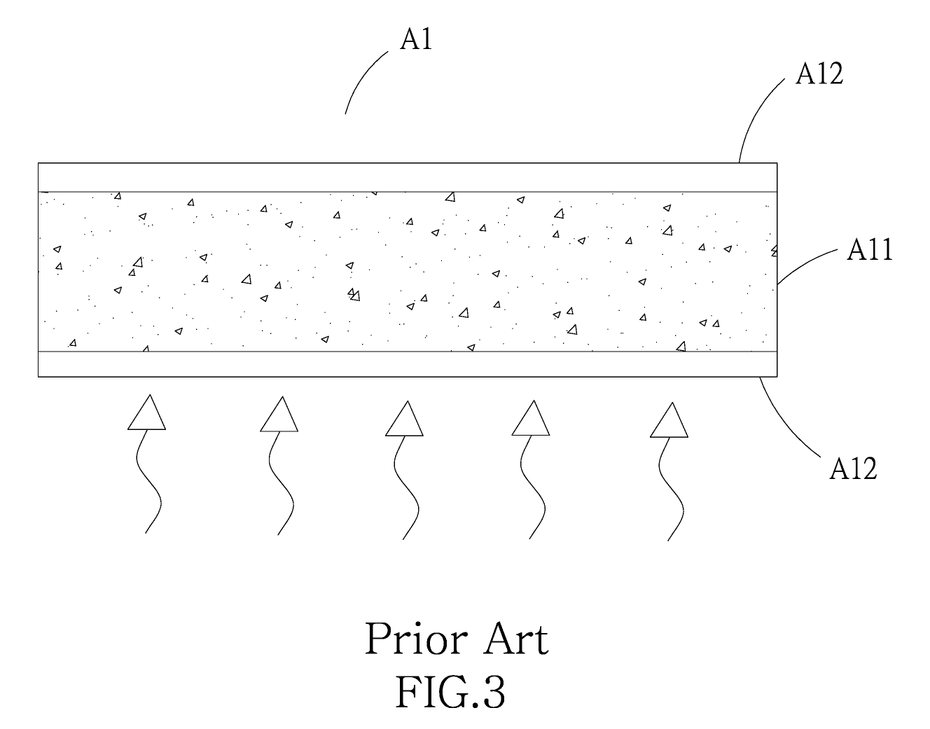

FIG. 4 is a view similar to FIG. 3 showing air trapped in the foam core exiting the article by removing the top airproof layer;

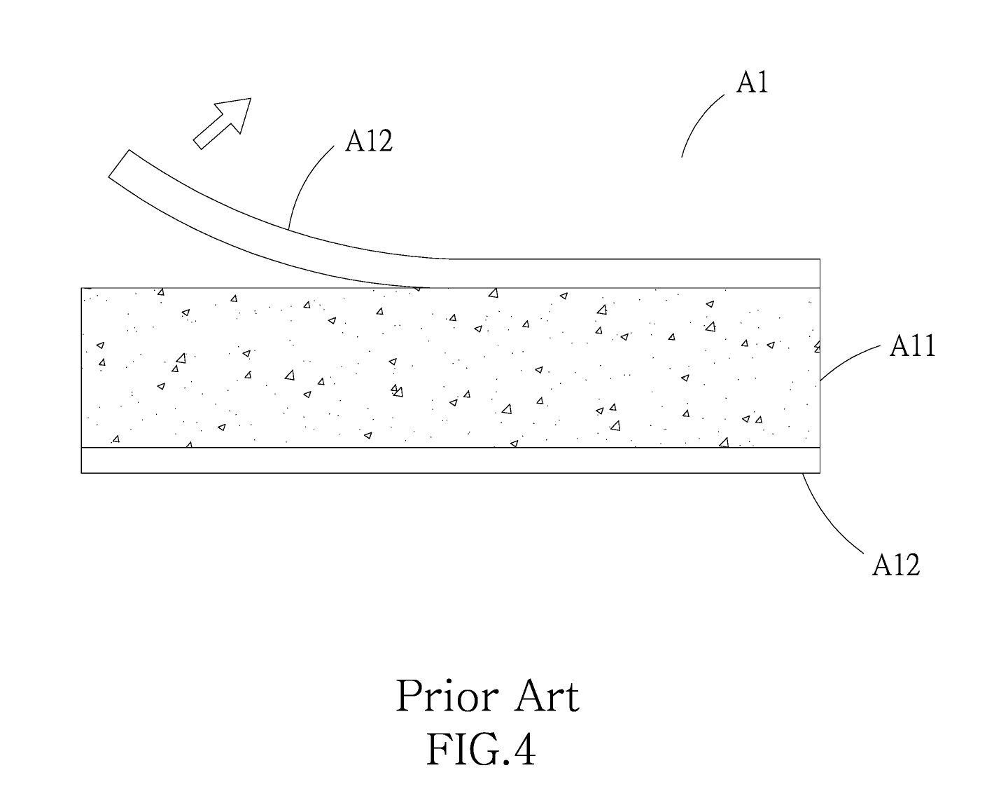

FIG. 5 is a flow chart illustrating a process of manufacturing foam molded articles according to the invention;

FIG. 6 is a perspective view of an open molding system employed by the process with release agent being applied into a female cavity section of the molding system by using an atomizer;

FIG. 7 is a view similar to FIG. 6 showing an expandable elastomeric polyurethane being injected into the female cavity section by using a nozzle;

FIG. 8 is a perspective view showing the closed molding system sent to a foaming device for foaming;

FIG. 9 is a perspective view of the molding system showing a foam molded article being removed from its female cavity section after finishing the foaming;

FIG. 10 is a perspective view of the foam molded article;

FIG. 11 is a longitudinal sectional view of the foam molded article; and

FIG. 12 is a perspective view showing the foam molded article served as a footwear insole with the foot rested thereon.

### DETAILED DESCRIPTION OF THE INVENTION

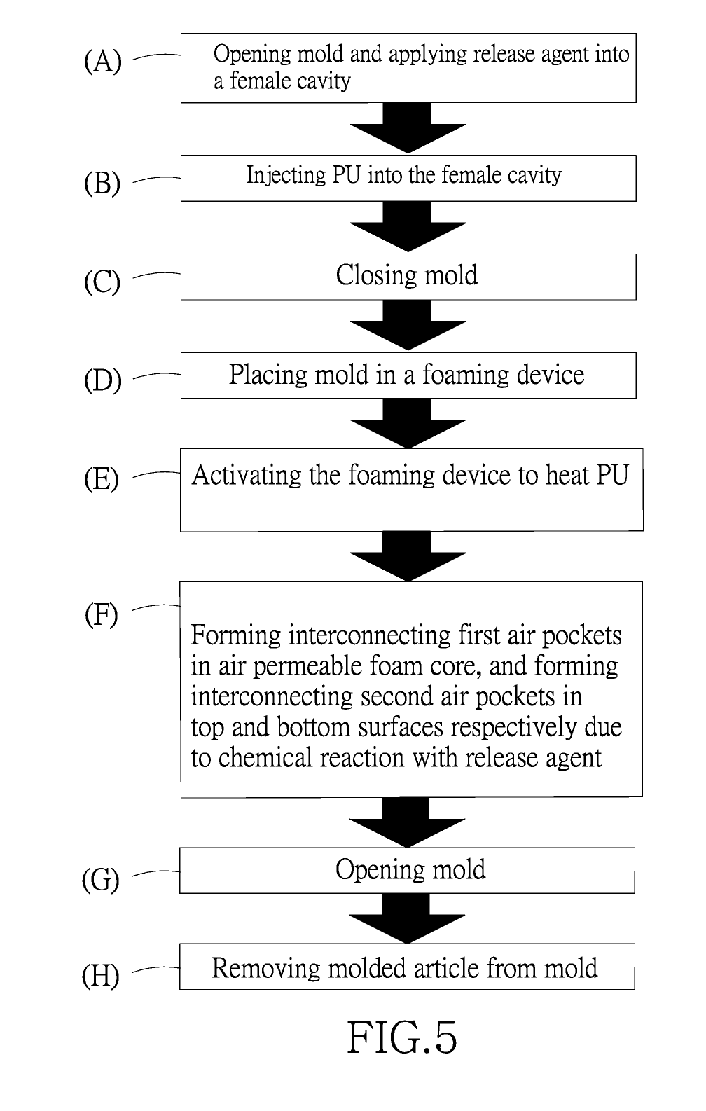

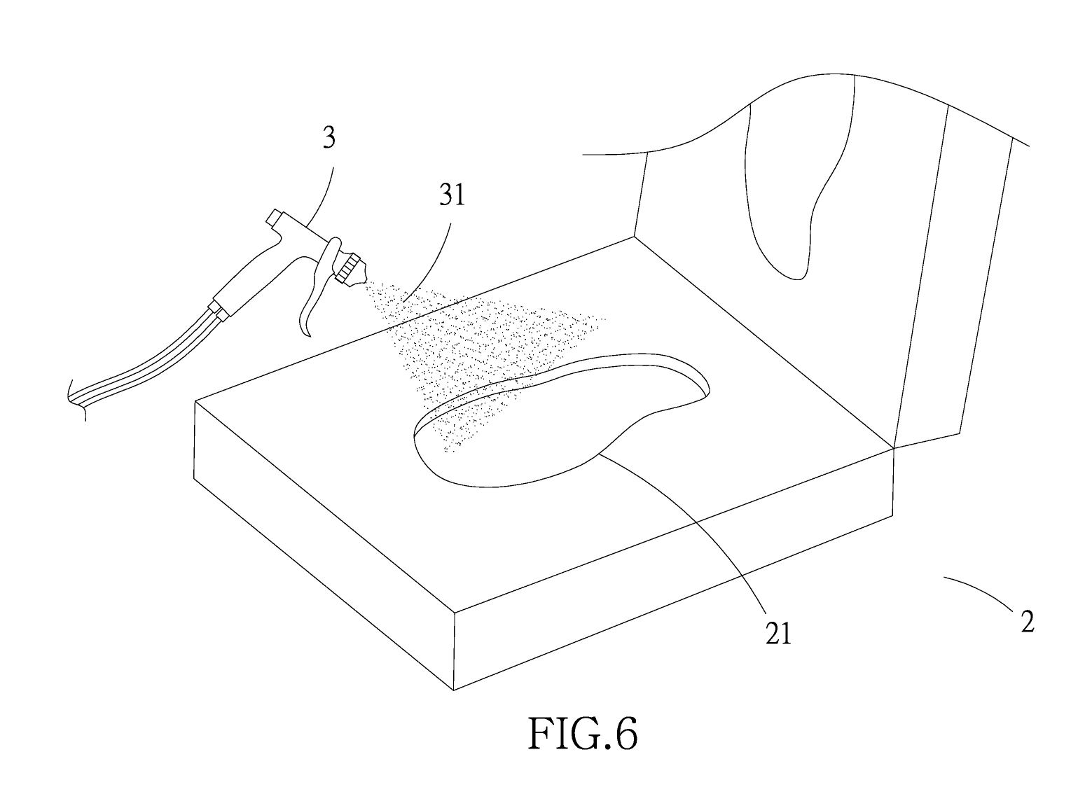

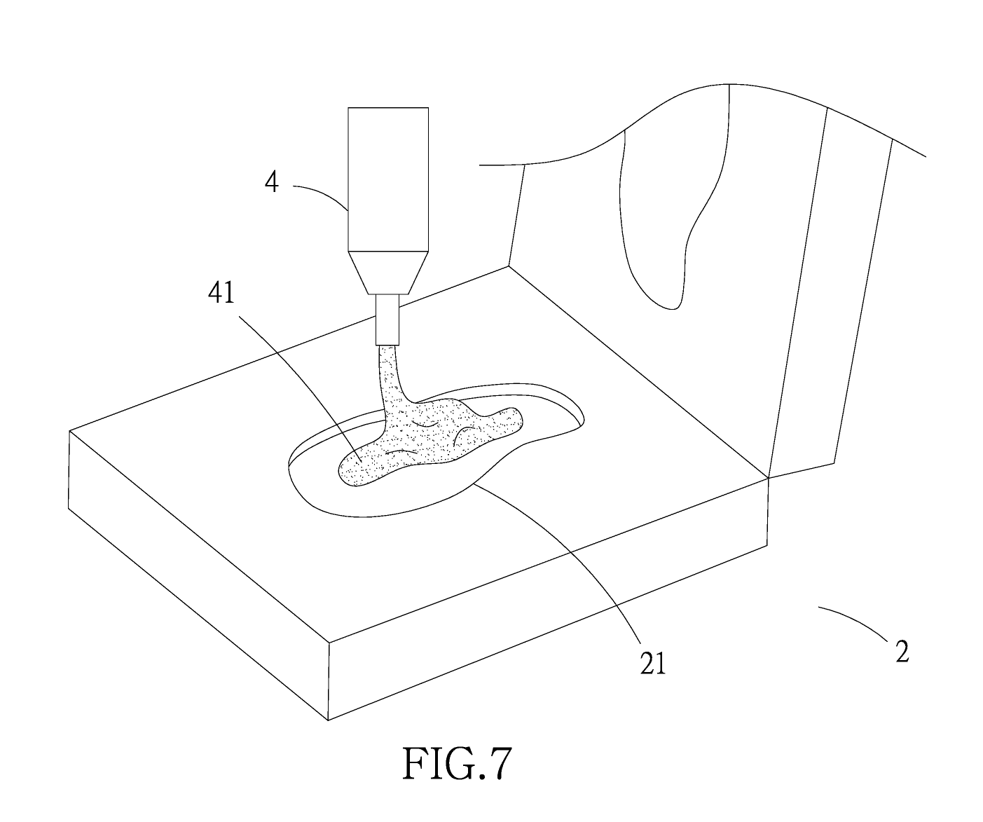

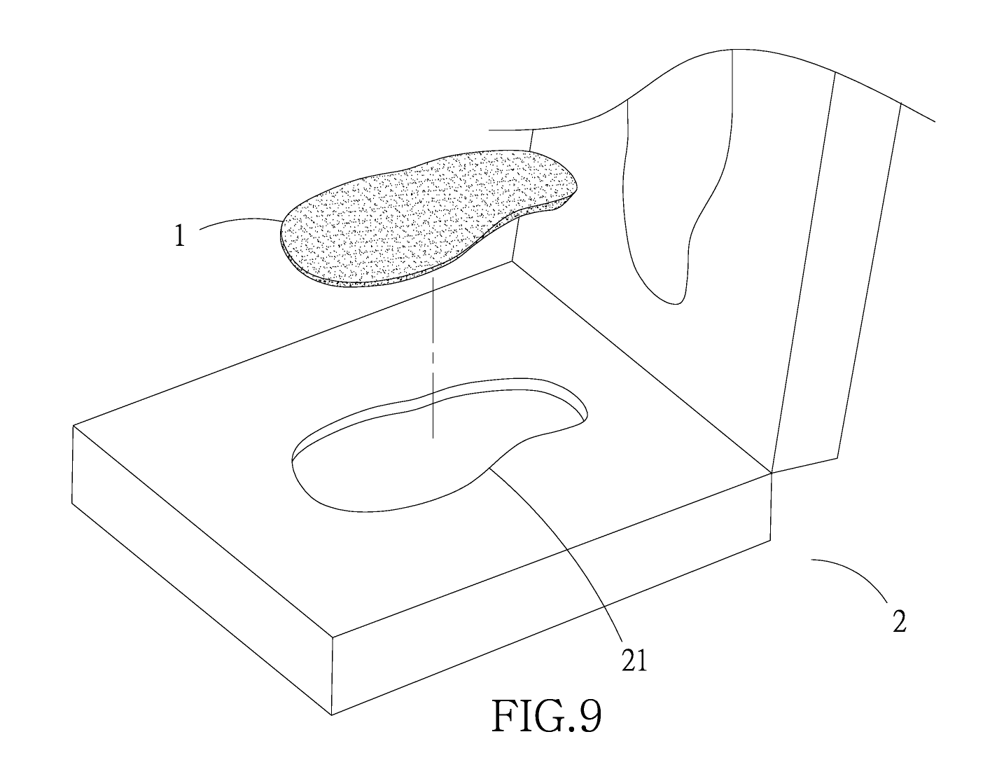

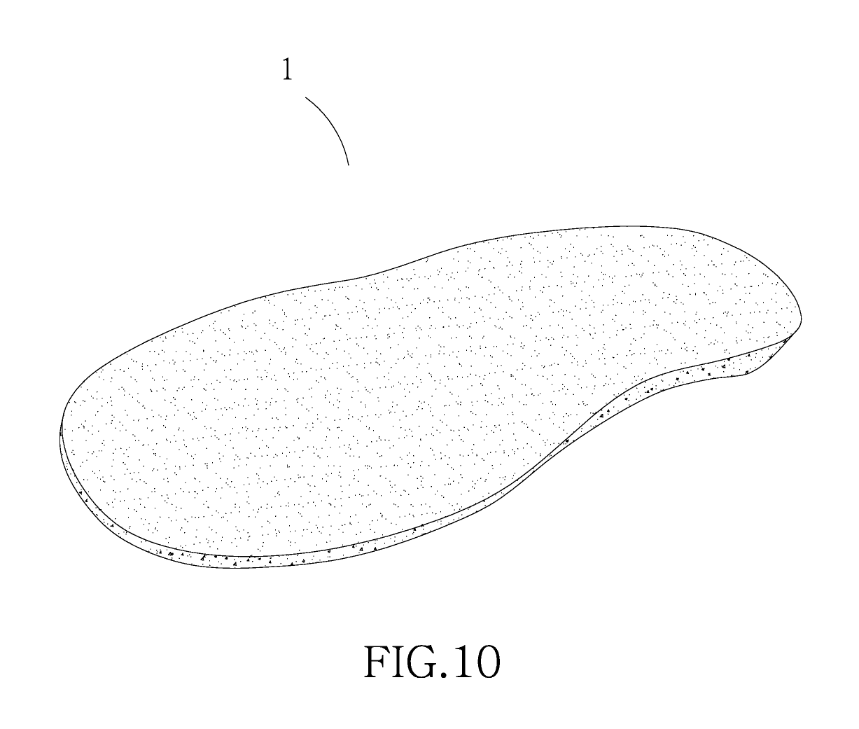

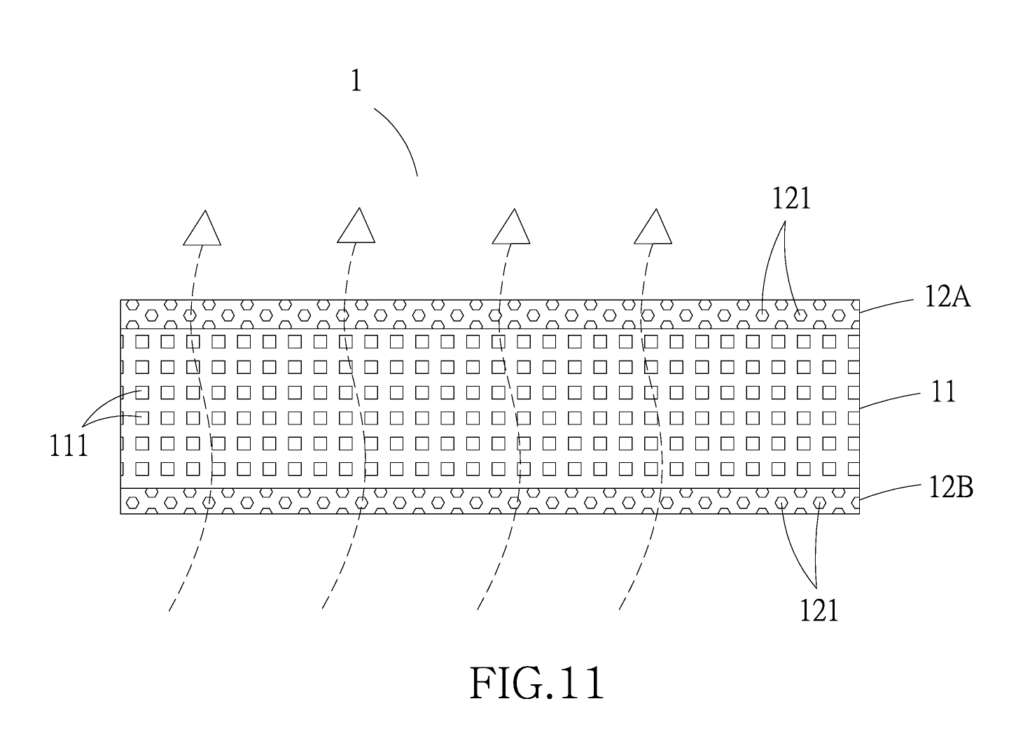

Referring to FIGS. 5 to 11, a process of manufacturing a foam molded article in accordance with the invention comprises the steps of (A) opening an open-closed molding system 2 and applying a release agent 31 into a female cavity section 21 of the molding system 2 by using an atomizer 3 (see FIG. 6); and (B) injecting an expandable elastomeric polyurethane (PU) 41 into the female cavity section 21 by using a nozzle 4 (see FIG. 7).

The female cavity section 21 is shaped as a footwear insole.

The expandable elastomeric PU 41 comprise a first material including polyether, chain extender, catalyst, surfactant and foaming agent; and a second material including diphenylmethane and isocyanate. Weight ratio of the first material to the second material is about 10 to 7.

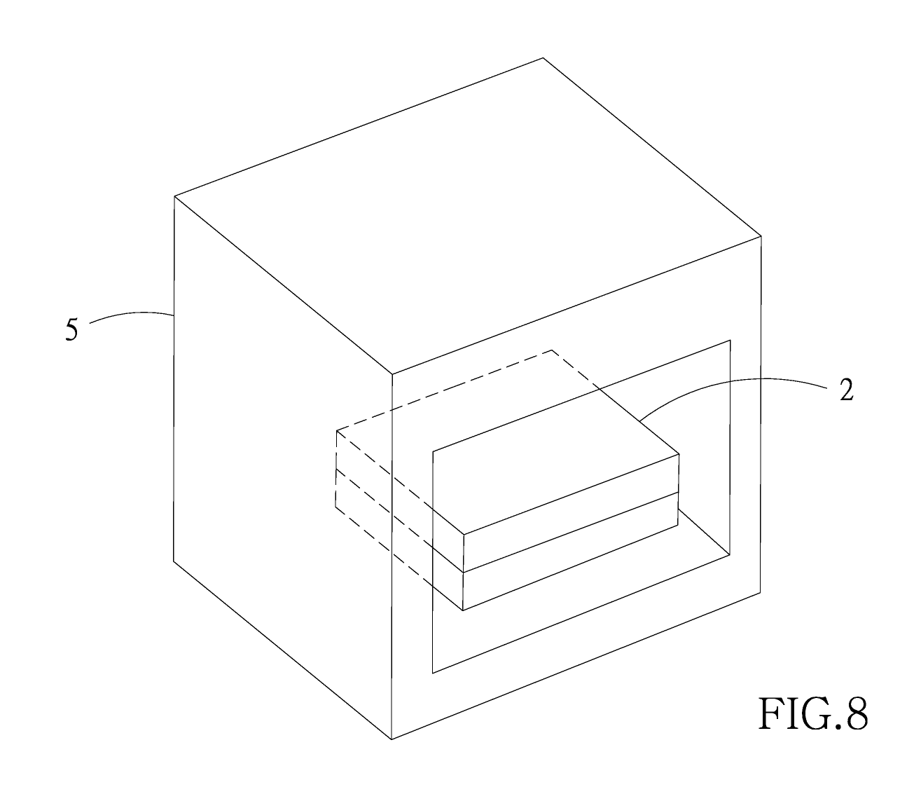

The process further comprises the steps of (C) closing the molding system 2; (D) placing the closed molding system 2 in a foaming device 5 (see FIG. 8); (E) activating the foaming device 5 to heat the expandable elastomeric PU 41; (F) forming a plurality of interconnecting first air pockets 111 in an air permeable foam core 11 of a foam molded article 1 to be formed, and forming a plurality of interconnecting second air pockets 121 in each of a top surface 12A and a bottom surface 12B of the foam molded article 1 respectively due to a chemical reaction with the release agent 31 wherein the first air pockets 111 are in air communication with the second air pockets 121; (G) opening the molding system 2; and (H) removing the foam molded article 1 from the molding system 2.

The foaming device 5 is a heating device.

It is envisaged by the invention that the foam molded articles 1 have a greatly improved air permeability due to the interconnecting first air pockets 111, the interconnecting second air pockets 121, and the air communication between the first air pockets 111 and the second air pockets 121.

It is further envisaged by the invention that the foam molded articles 1 can be manufacture in a single process without the need of further cutting or the like after being formed.

Preferably, the ratio of the first and second air pockets 111 and 121 to the substance of the foam molded article 1 is between 0.15 and 0.35.

Preferably, the foam molded article 1 can return to about 90% to 95% of its original size after being flexibly deformed.

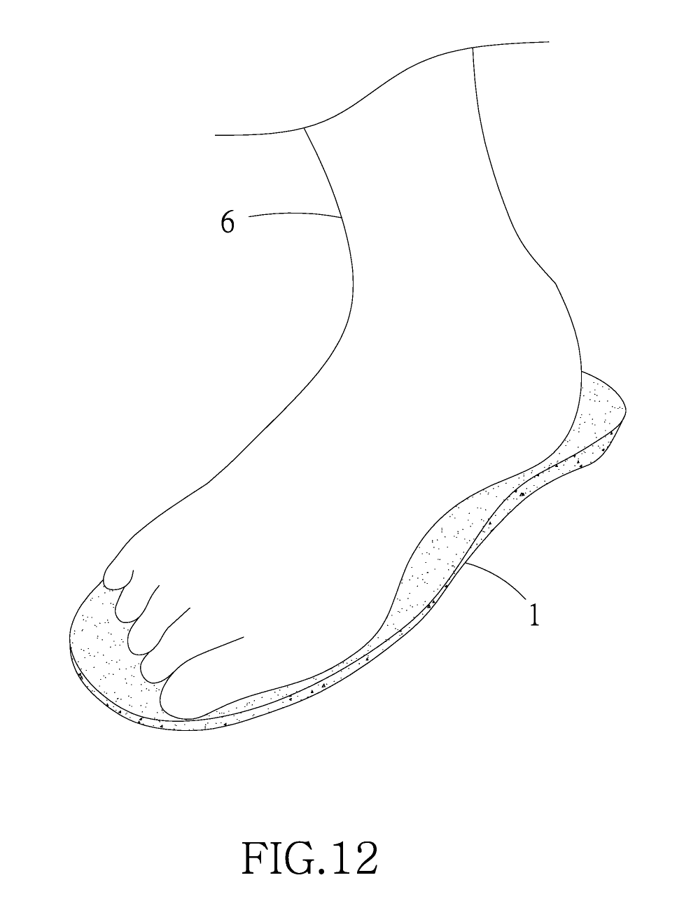

Referring to FIG. 12, in an embodiment of the invention the foam molded article 1 is a footwear insole. A person may feel a degree of comfort when his or her foot 6 is rested on the foam molded article 1.

While the invention has been described in terms of preferred embodiments, those skilled in the art will recognize that the invention can be practiced with modifications within the spirit and scope of the appended claims.

What is claimed is:

1. A process of manufacturing a foam molded article, comprising:
(A) opening an open-closed molding system;
(B) applying a release agent into a female cavity section of the molding system;
(C) injecting an expandable elastomeric polyurethane (PU) into the female cavity section;
(D) closing the molding system;
(E) placing the closed molding system in a foaming device;
(F) activating the foaming device to heat the expandable elastomeric PU;
(G) forming a plurality of interconnecting first air pockets in an air permeable foam core of a foam molded article to be formed;
(H) forming a plurality of interconnecting second air pockets in each of a top surface and a bottom surface of the foam molded article respectively by involving a chemical reaction with the release agent wherein the second air pockets are in air communication with the first air pockets;
(I) opening the molding system; and
(H) removing the finished foam molded article from the molding system.
